(19) United States
(12) Patent Application Publication
(10) Pub. No.: US 2008/0301688 A1
(43) Pub. Date: Dec. 4, 2008

(54) METHOD, SYSTEM, AND PROGRAM PRODUCT FOR ALLOCATING A RESOURCE

(76) Inventors: Gregory J. Boss, American Fork, UT (US); Christopher J. Dawson, Arlington, VA (US); Rick A. Hamilton, II, Charlottesville, VA (US); Timothy M. Waters, Hiram, GA (US)

Correspondence Address: HOFFMAN WARNICK LLC, 75 STATE ST, 14TH FLOOR, ALBANY, NY, 12207, US

(21) Appl. No.: 11/755,985

(22) Filed: May 31, 2007

(51) Int. Cl. G06F 9/46

(52) U.S. Cl. 718/104

(57) ABSTRACT

The invention provides a method, system, and program product for allocating a resource among a plurality of groups based on the role of each group within an organizational model. A method according to the invention may include, for example, granting a number of groups a privilege to bid on a resource, the privilege being based on a role of each group within an organizational model, accepting a bid for the resource from one or more of the groups, determining whether two or more groups have made equal, highest bids, in such a case, accepting a second bid from the groups having made equal, highest bids, and awarding a right to the resource to the group making the highest bid for the resource.

### CROSS-REFERENCE TO RELATED APPLICATIONS

This application is related in some aspects to commonly-owned U.S. patent application Ser. No. (to be provided), entitled “RESOURCE MANAGEMENT FRAMEWORK,” assigned attorney docket number END920060217US1, filed concurrently herewith, the entire contents of which are herein incorporated by reference.

This application is related in some aspects to commonly-owned U.S. patent application Ser. No. (to be provided), entitled “NON-DEPLETING CHIPS FOR OBTAINING DESIRED SERVICE LEVEL CHARACTERISTICS,” assigned attorney docket number END920060219US1, filed concurrently herewith, the entire contents of which are herein incorporated by reference.

This application is related in some aspects to commonly-owned U.S. patent application Ser. No. (to be provided), entitled “DISCRETE, DEPLETING CHIPS FOR OBTAINING DESIRED SERVICE LEVEL CHARACTERISTICS,” assigned attorney docket number END920060220US1, filed concurrently herewith, the entire contents of which are herein incorporated by reference.

This application is related in some aspects to commonly-owned U.S. patent application Ser. No. (to be provided), entitled “FLUID, DEPLETING CHIPS FOR OBTAINING DESIRED SERVICE LEVEL CHARACTERISTICS,” assigned attorney docket number END920060221US1, filed concurrently herewith, the entire contents of which are herein incorporated by reference.

This application is related in some aspects to commonly-owned U.S. patent application Sr. No. (to be provided), entitled “INTELLEGENT BUYER'S AGENT USAGE FOR ALLOCATION OF SERVICE LEVEL CHARACTERISTICS,” assigned attorney docket number END920060222US1, filed concurrently herewith, the entire contents of which are herein incorporated by reference.

This application is related in some aspects to commonly-owned U.S. patent application Ser. No. (to be provided), entitled “SCALING OFFERS FOR ELEMENTAL BIDDABLE RESOURCES (EBRs),” assigned attorney docket number END920060230US1, filed concurrently herewith, the entire contents of which are herein incorporated by reference.

### FIELD OF THE INVENTION

The invention relates generally to resource allocation, and more particularly, to a method, system, and program product for allocating a resource among a plurality of groups based on the role of each group within an organizational model.

### BACKGROUND OF THE INVENTION

Businesses and other organizations often must make difficult decisions regarding the allocation of limited resources among its component groups and/or among its customers or business partners. Often, such resources include information technology (IT) resources, but any type of resource may be subject to such allocation.

A deficiency of most methods of resource allocation is that they fail to adequately consider the varying importance of different resources to component groups of an organization. For example, a particular resource may be critically important to the functioning of one group and merely a desirable resource for another group. The failure to properly allocate such a resource can result in harm to the organization as a whole.

In an effort to ensure that all groups needing a resource have access to at least a portion of the resource, one approach includes allocating a portion of the resource to each group in proportion to its place in the organization (e.g., the proportion of employees of the organization working within the group, the proportion of the organization's overall budget apportioned to the group, etc.). However, as noted above, such an approach may allocate a portion of the resource to a group for whom the resource is merely desirable while that portion would be better “spent,” from the perspective of the organization as a whole, if it were allocated to another group, which may have received only a small portion of the resource due to its relatively small size within the organization.

Accordingly, there exists a need in the art to overcome the deficiencies and limitations described hereinabove.

### SUMMARY OF THE INVENTION

The invention provides a method, system, and program product for allocating a resource among a plurality of groups based on the role of each group within an organizational model. In one embodiment, a method according to the invention includes granting each of a plurality of groups a privilege to bid on a resource, the privilege being based on a role of the group within an organizational model; accepting at least one bid for the resource from at least one of the plurality of groups; determining whether two or more groups have made equal, highest bids; in the case that two or more groups have made equal, highest bids, accepting a second bid from at least one of the two or more groups having made equal, highest bids; and awarding a right to the resource to the group making the highest bid for the resource, wherein the granted privilege is different for at least two of the plurality of groups, such that a first privilege confers rights greater than a second privilege.

A first aspect of the invention provides a method for allocating a resource among a plurality of groups capable of using the resource, the method comprising: granting each of a plurality of groups a privilege to bid on a resource, the privilege being based on a role of the group within an organizational model; accepting at least one bid for the resource from at least one of the plurality of groups; and awarding a right to the resource to the group making the highest bid for the resource.

A second aspect of the invention provides a system for allocating a resource among a plurality of groups capable of using the resource, the system comprising: a system for granting each of a plurality of groups a privilege to bid on a resource, the privilege being based on a role of the group within an organizational model; a system for accepting at least one bid for the resource from at least one of the plurality of groups; and a system for awarding a right to the resource to the group making the highest bid for the resource.

A third aspect of the invention provides a program product stored on a computer-readable medium, which when executed, allocates a resource among a plurality of groups capable of using the resource, the program product comprising: program code for granting each of a plurality of groups a privilege to bid on a resource, the privilege being based on a role of the group within an organizational model; program code for accepting at least one bid for the resource from at least one of the plurality of groups; and program code for awarding a right to the resource to the group making the highest bid for the resource.

A fourth aspect of the invention provides a method for deploying an application for allocating a resource among a plurality of groups capable of using the resource, the method comprising: providing a computer infrastructure being operable to: grant each of a plurality of groups a privilege to bid on a resource, the privilege being based on a role of the group within an organizational model; accept at least one bid for the resource from at least one of the plurality of groups; and award a right to the resource to the group making the highest bid for the resource.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIGS. 1A-B show illustrative hierarchical and component organizational models, respectively.

FIG. 2 shows a block and flow diagram of an illustrative method according to an embodiment of the invention.

FIG. 3 shows an illustrative system according to an embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a method, system, and program product for allocating a resource among a plurality of groups based on the role of each group within an organizational model. Any known or later developed organizational model may be employed in practicing the present invention.

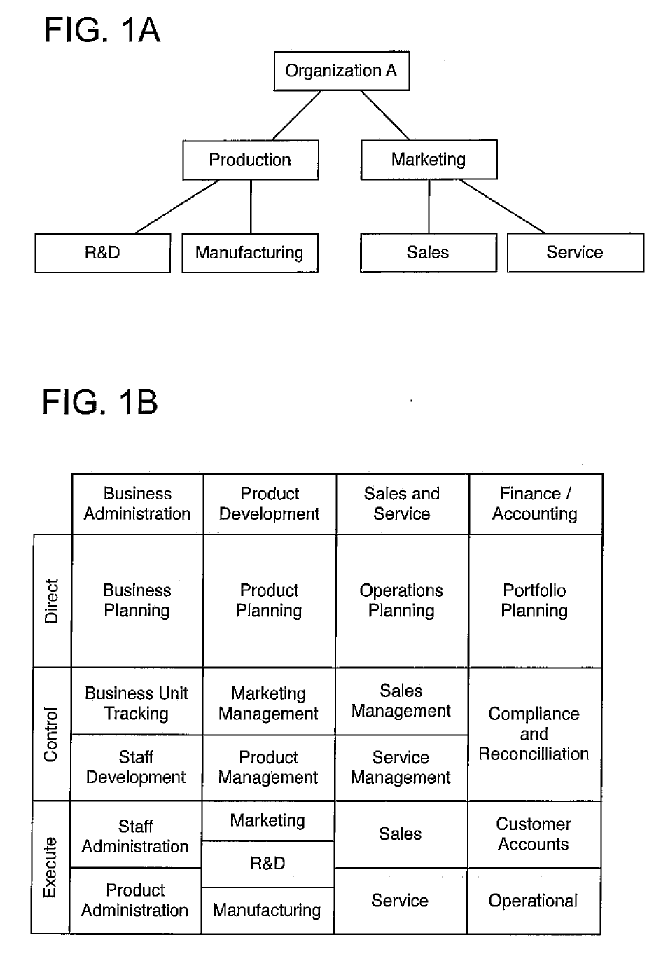

For example, FIG. 1A shows a schematic representation of a traditional hierarchical organizational model, wherein component business units operate with a great deal of autonomy and may have responsibility for several core business functions. As shown in FIG. 1A, Organization A may be viewed as comprised of two main departments, Production and Marketing, each of which is comprised of two subdepartments: R&D and Manufacturing; and Sales and Service, respectively. In such an organizational model, resources may be allocated to the main departments, Production and Marketing, with each then determining how to allocate the resources among their subdepartments. Alternatively, resources may be allocated to each subdepartment directly.

FIG. 1B shows a schematic representation of a component business model (CBM), which organizes a business around business units (columns) and business processes (rows). Generally, business process groups have responsibilities that cross boundaries with many business units. Similarly, business functions may be influenced by many business processes. As with the hierarchical organizational model of FIG. 1A, resources may be allocated directly to business functions or may be first allocated to a superseding authority.

The organizational models shown in FIGS. 1A-B are merely illustrative of the types of organizational models that may be employed in practicing the invention. Other types of organizational models, including later-developed models, are within the scope of the invention.

Rather than allocating resources directly to a business division or subdivision, the present invention grants a privilege to bid on the resource to groups within an organization. These privileges, referred to herein as “chips,” may be granted to groups at any level in the organizational model (e.g., directly to a subdivision or to a main division that then grants the chips to its own subdivisions).

Chips may be granted in any number of ways. For example, since the organization has likely allocated a proportion of its budget to each group within the organization, chips may be awarded in a similar manner (e.g., if Sales is to receive 10% of the organization's overall budget, Sales may also be granted 10% of the chips).

Alternatively, chips may be granted based on an expressed need of a group or groups. Such a need may include, for example, the group's business or contractual commitments both within and outside the organization. A contractual commitment to a third-party may, for example, represent a greater need than a non-contractual commitment within the organization.

In another embodiment, chips may be granted based on a group's contribution to the organization (e.g., if Sales is viewed as having contributed 40% of the organization's value, the group may be granted 40% of the chips).

In yet another embodiment, chips may be granted based on a business plan of the organization. For example, if the current focus of the organization is the generation of income, a larger proportion of chips may be granted to those groups most capable of generating income for the organization.

It should be noted that many other bases, or combinations of bases, for granting chips may be employed. For example, chips may be granted based on a combination of the proportion of the organization's budget and the organization's business plan. This may result, for example, in chips being granted in proportion to the group's share of the budget, but discounted or augmented based on the group's ability to further the business plan (e.g., Sales and R&D may comprise 10% and 20% of the organization's budget, but each may receive 15% of the chips if Sales is viewed as furthering the business plan (e.g., income generation) and R&D is not).

As explained above, the chips granted to a group merely grant the group the privilege of bidding on a particular resource. A group must decide how many chips to bid, if any. For example, if a first resource available for bid is merely desirable to the group, it may be more advantageous for the group not to bid on the resource and then bid most or all of its chips in an attempt to obtain a needed resource.

In some embodiments of the invention, different groups are granted different chips, with the different chips conferring different bidding privileges. For example, a first type of chip may entitle the group to bid on a resource more than once or may allow the group to see the bids of other groups before making its own bid. Alternatively, bidding for some resources may be restricted to groups having been granted a first type of chip. Thus, groups granted the first type of chip are granted greater bidding privileges than a group not granted the first type of chip.

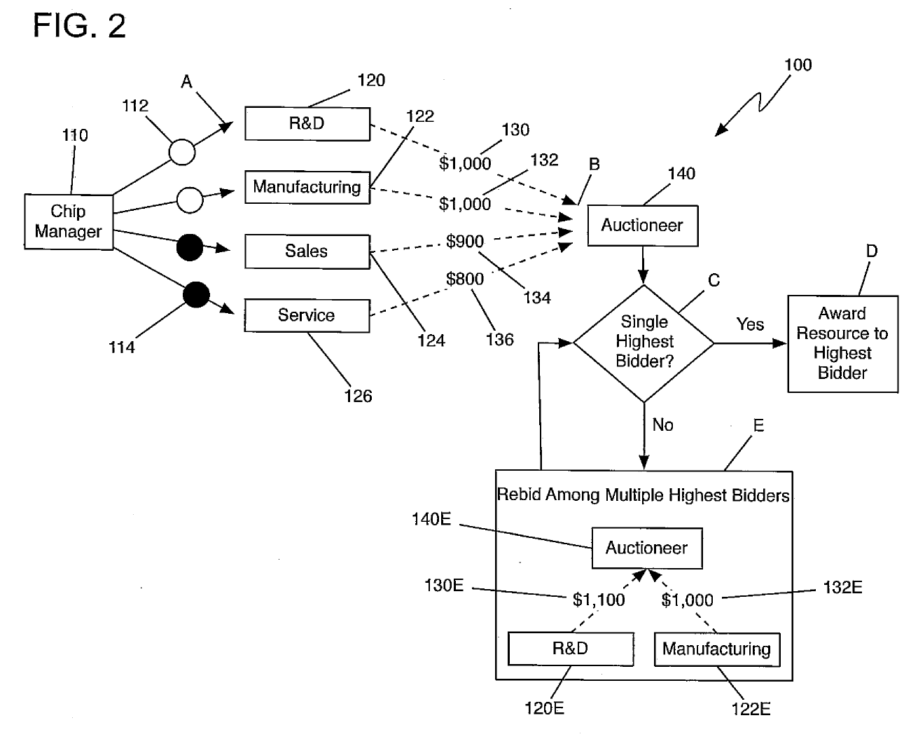

FIG. 2 shows a block and flow diagram of an illustrative method 100 according to the invention. A chip manager 110 grants A chips 112, 114 to each of a plurality of groups 120-126 of the organizational model shown in FIG. 1A. As shown in FIG. 2, chips 112, 114 may be of a first type 112 and a second type 114. Here, first type chips 112 allow a group to see the bids made by groups granted second type chips 114 before making a bid. Thus, Sales 124 and Service 126 bid B $900 136 and $800 134, respectively. However, having been granted first type chips 112, Manufacturing 122 and R&D 120 observed the bids of Sales 124 and Service 126 and each bid $1,000 130, 132.

Granting first type chips 112 and second type chips 114 to different groups may be advantageous, for example, in order to further a business plan, as explained above. Here, it may have been determined that Manufacturing 122 and R&D 120 are better able to further that business plan than are Sales 124 and Service 126.

In any case, Auctioneer 140 accepts the bids 130-136 and determines C whether there was a single highest bidder. If so (i.e., Yes at C), the resource is awarded to the highest bidder at D. If not (i.e., No at C), the multiple highest bidders rebid E on the resource. Upon rebidding at E, R&D 120E makes a bid of $1,100 130E, while Manufacturing 122E makes a bid of $1,000 132E, each of which is accepted by Auctioneer 140E. Again, it is determined C whether there is a single highest bidder. Upon rebidding at E, R&D 120E would be awarded the resource at D.

Allocating a resource according to the present invention provides improved efficiencies in service level agreements (SLAs). Rather than being static agreements, as currently known in the art, the present invention transforms SLAs into dynamic agreements, whereby a customer may pay the same price for a service as under a static SLA, but the level of service (e.g., availability of resources) to the customer changes during the term of the agreement. Such changes in service make more efficient use of the provider's resources by allocating a larger or smaller proportion of the resources to the customer based on the customer's needs and/or the competing needs of other customers. A service provider may therefore be able to adequately serve a number of customers using fewer total resources than would be expected based on the peak needs of each customer.

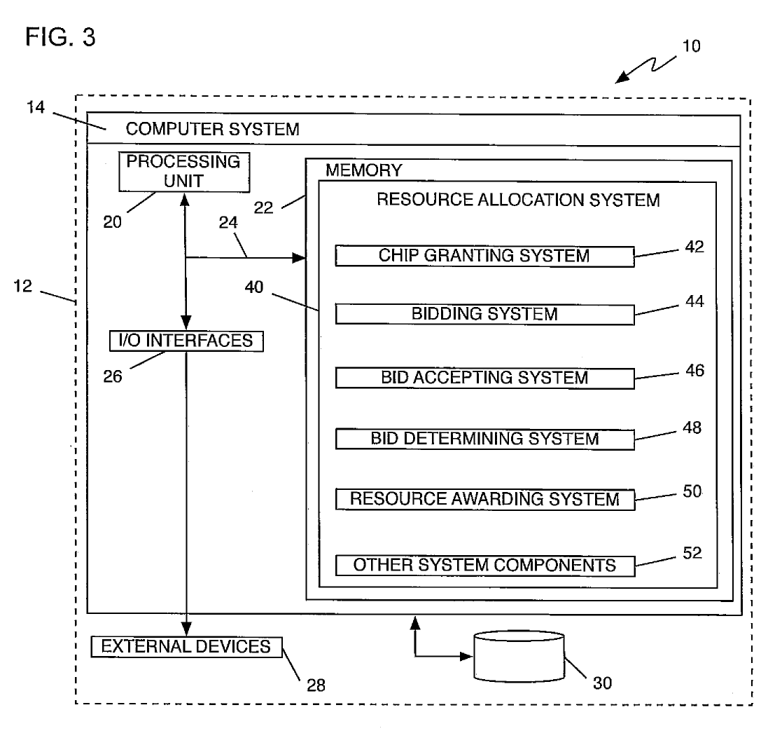

FIG. 3 shows an illustrative system 10 for allocating a resource among a plurality of groups. To this extent, system 10 includes a computer infrastructure 12 that can perform the various process steps described herein for allocating a resource among a plurality of groups. In particular, computer infrastructure 12 is shown including a computer system 14 that comprises a resource allocation system 40, which enables computer system 14 to allocate a resource among a plurality of groups by performing the process steps of the invention.

Computer system 14 is shown including a processing unit 20, a memory 22, an input/output (I/O) interface 26, and a bus 24. Further, computer system 14 is shown in communication with external devices 28 and a storage system 30. As is known in the art, in general, processing unit 20 executes computer program code, such as resource allocation system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and resource allocation system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, resource allocation system 40 enables computer system 14 to allocate a resource among a plurality of groups. To this extent, resource allocation system 40 is shown including a chip granting system 42, a bidding system 44, a bid accepting system 46, a bid determining system 48, and a resource awarding system 50. Operation of each of these systems is discussed above. Resource allocation system 40 may further include other system components 52 to provide additional or improved functionality to resource allocation system 40. It is understood that some of the various systems shown in FIG. 3 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for allocating a resource among a plurality of groups, it is understood that the invention further provides various alternative embodiments. For example, in one embodiment, the invention provides a computer-readable medium that includes computer program code to enable a computer infrastructure to allocate a resource among a plurality of groups. To this extent, the computer-readable medium includes program code, such as resource allocation system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to allocate a resource among a plurality of groups, as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for allocating a resource among a plurality of groups. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for allocating a resource among a plurality of groups capable of using the resource, the method comprising:
granting each of a plurality of groups a privilege to bid on a resource, the privilege being based on a role of the group within an organizational model;
accepting at least one bid for the resource from at least one of the plurality of groups; and
awarding a right to the resource to the group making the highest bid for the resource.

2. The method of claim 1, wherein the resource includes an information technology (IT) resource.

3. The method of claim 1, wherein the role of the group within the organizational model includes at least one criterion selected from a group consisting of: a budget allocated to the group, a commitment of the group to another group within the organizational model, a commitment of the group to an entity outside the organizational model, an ability of the group to generate revenue, an ability of the group to realize a cost savings, the ability of the group to avoid a cost, and the ability of the group to provide a competitive advantage.

4. The method of claim 1, wherein the organizational model includes at least one model selected from a group consisting of: a hierarchical organizational model and a component business model (CBM).

5. The method of claim 1, wherein the granted privilege is different for at least two of the plurality of groups, such that a first privilege confers rights greater than a second privilege.

6. The method of claim 5, wherein a first privilege permits a group to bid for the resource a greater number of times.

7. The method of claim 5, wherein a first privilege permits a group to see the bids made by a group granted a second privilege before bidding on the resource.

8. The method of claim 5, wherein accepting includes accepting bids from a group granted a first privilege and not accepting bids from a group granted a second privilege.

9. The method of claim 1, further comprising:
determining whether two or more groups have made equal, highest bids; and
in the case that two or more groups have made equal, highest bids, accepting a second bid from at least one of the two or more groups having made equal, highest bids.

10. A system for allocating a resource among a plurality of groups capable of using the resource, the system comprising:
a system for granting each of a plurality of groups a privilege to bid on a resource, the privilege being based on a role of the group within an organizational model;
a system for accepting at least one bid for the resource from at least one of the plurality of groups; and
a system for awarding a right to the resource to the group making the highest bid for the resource.

11. The system of claim 10, wherein the resource includes an information technology (IT) resource.

12. The system of claim 10, wherein the granted privilege is different for at least two of the plurality of groups, such that a first privilege confers rights greater than a second privilege.

13. The system of claim 12, wherein a first privilege permits at least one of the following: a group to bid for the resource a greater number of times and a group to see the bids made by a group granted a second privilege before bidding on the resource.

14. The system of claim 12, wherein the system for accepting includes a system for accepting bids from a group granted a first privilege and not accepting bids from a group granted a second privilege.

15. The system of claim 10, further comprising:
a system for determining whether two or more groups have made equal, highest bids; and
a system for accepting a second bid from at least one of the two or more groups having made equal, highest bids.

16. A program product stored on a computer-readable medium, which when executed, allocates a resource among a plurality of groups capable of using the resource, the program product comprising:
program code for granting each of a plurality of groups a privilege to bid on a resource, the privilege being based on a role of the group within an organizational model;
program code for accepting at least one bid for the resource from at least one of the plurality of groups; and
program code for awarding a right to the resource to the group making the highest bid for the resource.

17. The program product of claim 16, wherein the granted privilege is different for at least two of the plurality of groups, such that a first privilege confers rights greater than a second privilege.

18. The program product of claim 17, wherein a first privilege permits at least one of the following: a group to bid for the resource a greater number of times and a group to see the bids made by a group granted a second privilege before bidding on the resource.

19. The program product of claim 17, wherein the program code for accepting includes program code for accepting bids from a group granted a first privilege and program code for not accepting bids from a group granted a second privilege.

20. The program product of claim 16, further comprising:
program code for determining whether two or more groups have made equal, highest bids; and
program code for accepting a second bid from at least one of the two or more groups having made equal, highest bids.

21. A method for deploying an application for allocating a resource among a plurality of groups capable of using the resource, the method comprising:
providing a computer infrastructure being operable to:
grant each of a plurality of groups a privilege to bid on a resource, the privilege being based on a role of the group within an organizational model;
accept at least one bid for the resource from at least one of the plurality of groups; and
award a right to the resource to the group making the highest bid for the resource.
